(19) United States
(12) Patent Application Publication
(10) Pub. No.: US 2005/0013648 A1
(43) Pub. Date: Jan. 20, 2005

(54) Arrangement applied in package

(76) Inventor: Antonio S. Moutinho, Alphaville (BR)

Correspondence Address: MCKEE, VOORHEES & SEASE, P.L.C., 801 GRAND AVENUE, SUITE 3200, DES MOINES, IA, 50309-2721, US

(21) Appl. No.: 10/891,209

(22) Filed: Jul. 14, 2004

(30) Foreign Application Priority Data
Jul. 18, 2003 (BR) MU 8301726-7

(51) Int. Cl. A46B 5/02; B05C 21/00

(52) U.S. Cl. 401/6; 401/196

(57) ABSTRACT

“ARRANGEMENT APPLIED IN PACKAGE”, notably to hold a liquid, colored, specific to recover the esthetics of thread0s, or mortar surfaces between ceramic pieces, or even internal and external areas of buildings in general, including façades; characterized by a plastic tube (1) ergonomically designed, being equipped with a threaded nozzle (2), preferably of rigid PVC, which receives highly-resistant wedge-shaped foam (7); the plastic tube (1) has a lower cylindrical part (3), an intermediate cone-shaped trunk region (4), e a substantially cylindrical upper segment (5) followed by an inverted cone-shaped trunk terminal (6), to finally reach the threaded nozzle (2).

This application for a utility model patent concerns a new “ARRANGEMENT APPLIED IN PACKAGE”, which consists of a plastic tube whose lines provide a grip similar to that of a pen, with a tip made of highly resistant foam soaked by the liquid contained in the package. This allows its application to slender surfaces with a high degree of rugosity.

Its advantages are ease of application and appropriate ergonomics.

In the current STATE OF THE ART, this kind of package (squeeze tube type) has its function limited to the application of certain footwear paints and some hygiene and cleaning products.

The innovation is an ergonomically designed plastic tube whose lines form a grip that facilitates its handling. It has a screw-on tip, preferably of rigid PVC, which receives a highly resistant wedge-shaped foam. When the package is tipped in the direction of the foam, the latter is soaked by the liquid contained in the package. This allows the liquid in the foam to be applied in a controlled manner, with respect to quantity, on restricted and/or slender surfaces with a high degree of rugosity, such as on ceramic or stone cement threads.

The model will be explained more clearly through the drawings listed below:

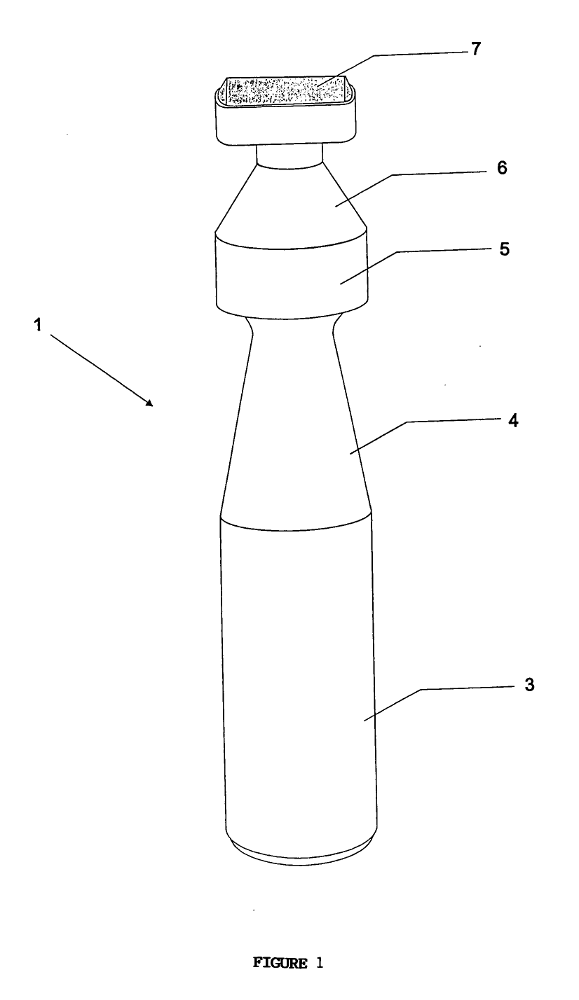

FIG. 1: Drawing in perspective of the arrangement applied in package;

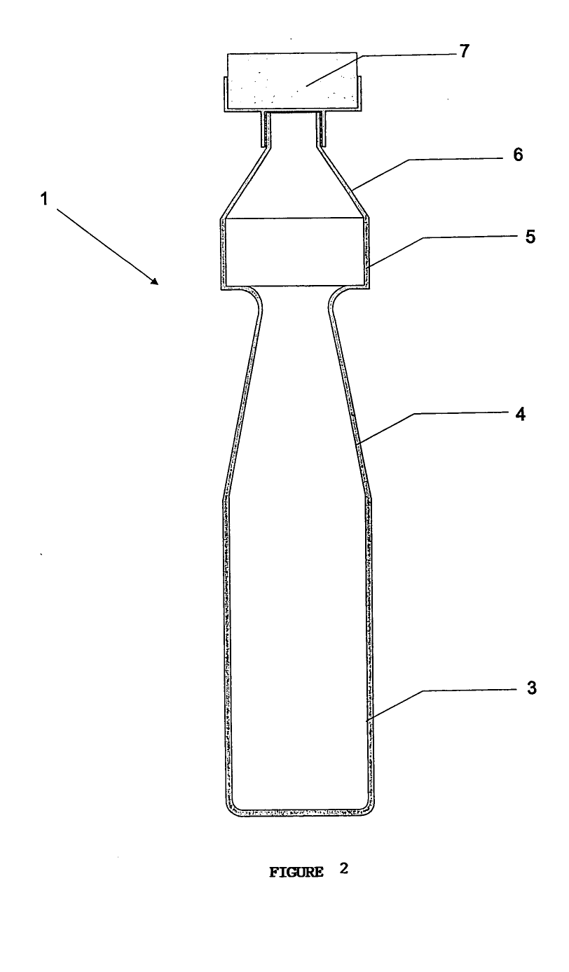

FIG. 2: Cross section of the arrangement applied in package;

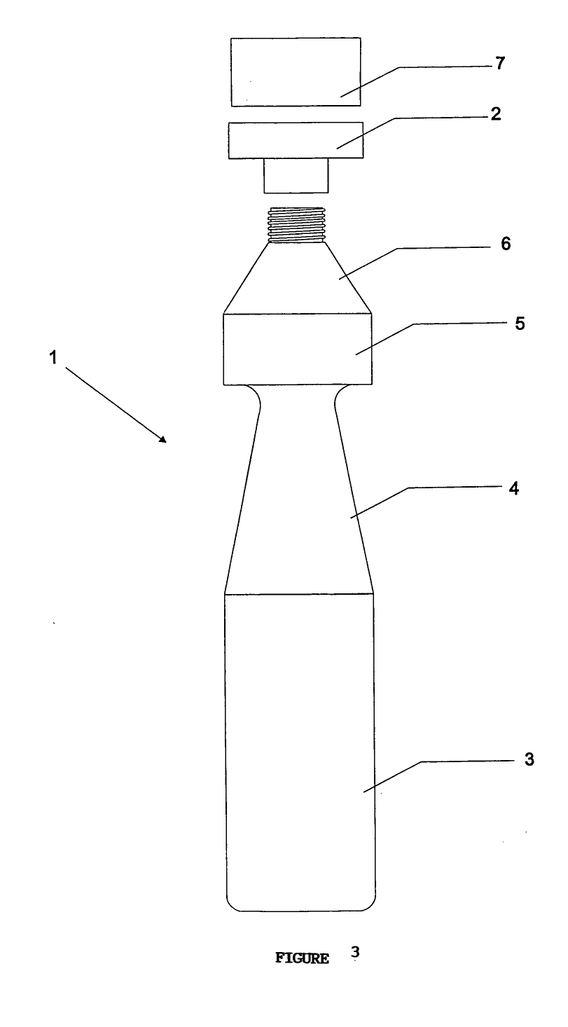

FIG. 3: Exploded view of the arrangement applied in package.

The “ARRANGEMENT APPLIED IN PACKAGE”, which is the object of this application for a Utility Model Patent, consists of a package similar to a squeeze tube, formed by an ergonomically designed plastic tube (1) whose lines form a grip that facilitates its handling. It has a screw-on tip (2), preferably of rigid PVC, which receives a highly resistant wedge-shaped foam (7).

The plastic tube (1) has a cylindrical lower part (3), an intermediate cone-shaped trunk region (4) to allow greater flow velocity, and a substantially cylindrical upper section (5) followed by an inverted cone terminal (6), finally arriving at the screw-on tip (2).

The tip (2) receives a highly resistant wedge-shaped foam (7). When the package is tipped in the direction of the foam (7), the latter is soaked by the liquid contained in the package. This allows the liquid in the foam (7) to be applied in a controlled manner, with respect to quantity, on restricted and/or slender surfaces with a high degree of rugosity, such as on ceramic or stone cement threads.

The product contained in the package is a colored liquid, specifically for recovering the aesthetic appearance of threads, or grout surfaces between ceramic parts, or even in internal or external areas of buildings in general, including facades. The liquid contained in it consists of styrenated acrylic emulsion, inert minerals, inorganic pigments, aliphatic hydrocarbons, glycols and etoxylated and carboxylated tenso-active substances.

The application is made on the placement joints, between the parts, squeezing the tube and sliding the foam over the surface.

1) “ARRANGEMENT APPLIED IN PACKAGE”, notably to hold a liquid, colored, specific to recover the esthetics of thread0s, or mortar surfaces between ceramic pieces, or even internal and external areas of buildings in general, including façades; characterized by a plastic tube (1) ergonomically designed, being equipped with a threaded nozzle (2), preferably of rigid PVC, which receives highly-resistant wedge-shaped foam (7); the plastic tube (1) has a lower cylindrical part (3), an intermediate cone-shaped trunk region (4), e a substantially cylindrical upper segment (5) followed by an inverted cone-shaped trunk terminal (6), to finally reach the threaded nozzle (2).
